(19) United States
(12) Patent Application Publication
(10) Pub. No.: US 2017/0228340 A1
(43) Pub. Date: Aug. 10, 2017

(54) CALCULATION METHOD FOR DESIGNING RELUCTANCE SYSTEMS, AND COMPUTER PROGRAM

(71) Applicant: Hans-Jurgen Remus, Hannover (DE)

(72) Inventor: Hans-Jurgen Remus, Hannover (DE)

(21) Appl. No.: 15/503,304

(22) PCT Filed: Aug. 7, 2015
(86) PCT No.: PCT/EP2015/001636

§ 371 Date: Feb. 10, 2017

(30) Foreign Application Priority Data
Aug. 12, 2014 (DE) 10 2014 011 911.4

(51) Int. Cl. G06F 17/11; H02K 19/10

(52) U.S. Cl. CPC G06F 17/11; H02K 19/103; H02K 2201/03; G06F 17/5095

(57) ABSTRACT

The invention relates to a calculation method for designing reluctance systems by balancing the inner and outer system energy using the equation W=^{1/2}Λ (Θₐ²+Θ_{b}²+2ΘₐΘ_{b}), where 2ΘₐΘ_{b}≠0, according to claim 1. The invention further relates to a computer program comprising program code means, in particular a computer program stored on a machine-readable medium, for carrying out the disclosed calculation method when the computer program is executed on a computer.

This application is entitled to the benefit of, and incorporates by reference essential subject matter disclosed in PCT Application No. PCT/EP2015/001636 filed on Aug. 7, 2015, which claims priority to German Application No. 10 2014 011 911.4 filed Aug. 12, 2014.

The invention relates to a calculation method for designing reluctance systems by balancing the inner and outer system energy. The invention further relates to a computer program comprising program code means, in particular a computer program stored on a machine-readable medium for carrying out the method embodiments described herein when the computer program is executed on a computer.

### BACKGROUND INFORMATION

Between carriers of electric charges, between magnets, between current-carrying lines and between magnetic poles and electric conduction flows, there are forces. The employment of electric motors in the automotive field is becoming increasingly important. In transport technology, linear motors are replacing conventional pulling devices. This requires new calculation methods for the unconventional energy converters that are being used more and more frequently and becoming increasingly geometrically complex.

The dimensions of such technical systems with complex geometry must be optimized under the influence of the magnetic saturation. So far, there have been three methods for describing the static and dynamic properties of variable reluctance systems: calculations using the Maxwell stress tensor, calculations using energy balancing and calculations based on an equivalent circuit diagram.

All three methods require knowledge of the system's field distribution to be able to calculate the forces or moments. In the case of the Maxwell stress tensor, the body forces are attributed to equivalent surface tensions, while in the case of energy balancing, the energy divisions can be clearly described by means of volume integrals. The equivalent circuit diagram as a discrete, idealized representation of an energy division describes the technical system under limiting preconditions.

However, the three calculation approaches yield different results under the same preconditions. The energy balancing according to the state of science and art is in the following explained in more detail.

Principally, it must be noted that a calculation method of such reluctance systems must be designed in a maximal variable manner so it can be based on material functions rather than on material constants. In doing so, an empirically given function D=D(E) or inverse function E=E(D) as electrification function is assumed as a basis. H=H(B) or the inverse function B=B(H), which is also empirical and assumed as a magnetization function, is taken as a basis (FIGS. 1, 2, 3). These functions are bases of a more general theory, which also applies to the material-related constants ε (permittivity) and μ (permeability) of the proportional theory.

Due to the non-linearity of the soft iron magnetization function, the superposition principle can however not be employed. In addition, the corresponding calculation method is also developed based on the assumption of clear material functions, no hysteresis and isotropy.

The general approach

B̅=μH̅+M̅ Equation 001

describes

the proportional theory with M̅=0, ∂μ/∂H=0

the magnetically soft substances with M=0

B=B (H) clear function with the point (0,0)

μ=μ(H)

and

∂B/∂H=μ_{d}(H)

positive functions

the stabilized permanent magnets with M̅=const

μ=const and the secondary loops with μᵣₑᵥ=const

the permanent magnetic state trajectories with M̅=0
B=B(−H) in the range of −H_{c}≦H≦0 and wall ∂B/∂H=μ_{d}(−H),
B/(−H)=(−H) positive functions.

There are also the following quantities:

$$\frac{B ( H )}{H} = μ ( H ) , \frac{dB}{dH} = {μ}_{d} ( H )$$

where μ(H) is the permeability and the function μ_{d}(H) is the differential permeability. Corresponding values can be derived for the electrification function

D̅=εĒ+P̅ Equation 002

The expressions for the functions, on the basis of which the field forces and the inductance coefficients and capacity coefficients are determined, are to be derived according to the field theory, that means by the Maxwell equations and from the principle of maintaining the total energy of a closed system. This requires a finite volume τcarrier with electrical charges, conduction flows, permanent magnetization and the distributions of ε and μ. Since the work of the field forces must be determined when displacing the bodies, the Maxwell equations must be calculated in the following form:

$$\overline{J} + \frac{{d}^{′} \overline{D}}{dt} = rot \overline{H} \\ \frac{{d}^{′} \overline{B}}{dt} = - rot \overline{E} \qquad Equation 003$$

or in detailed form:

$$\begin{matrix}\overline{J} + \frac{\partial \overline{D}}{\partial t} + \overline{v} div \overline{D} + rot [ \overline{D} , \overline{v} ] = rot \overline{H} & Equation 004 A \\ \frac{\partial \overline{B}}{\partial t} + \overline{v} div \overline{B} + rot [ \overline{B} , \overline{v} ] = - rot \overline{E} & Equation 004 B\end{matrix}$$

If you multiply the Equation 004A by Ē, the Equation 004B by H̅, and add Equations 004A and 004B:

$$\begin{matrix}\overline{E} , \overline{J} + \overline{E} \frac{{d}^{′} \overline{D}}{dt} + \overline{H} \frac{{d}^{′} \overline{B}}{dt} = \overline{E} rot \overline{H} - \overline{H} rot \overline{E} \\ = div [ \overline{E} , \overline{H} ]\end{matrix}$$

and integrate over the volume τ and apply Gauss's theorem and assume for this theorem the normal π of each area element dĀ towards the inside, this yields following the state of the science and art, the following:

$$\int \int \int \{ \overline{E} , \overline{J} + \overline{E} \frac{{d}^{′} \overline{D}}{dt} + \overline{H} \frac{{d}^{′} \overline{B}}{dt} \} dτ = ∯ [ \overline{E} , \overline{H} ] d \overline{A} \qquad Equation 005$$

Assuming that the enveloping surface is infinite (the system itself is finite and complete) in the limit case:

$${lim}_{A \to ∞} ∯ [ \overline{E} , \overline{H} ] d \overline{A} = 0 \qquad Equation 006$$

the energy balance of the system is the following:

$$dt \int \int \int \{ \overline{E} , \overline{J} + \overline{E} \frac{{d}^{′} \overline{D}}{dt} + \overline{H} \frac{{d}^{′} \overline{B}}{dt} \} dτ = 0 \qquad Equation 007$$

### Herein

dt∫∫∫Ē·J̅dτ=dtPₜₕ Equation 008

is known as the total energy loss in the volume due to the current heat τ in the time span dt. If non-quasi-stationary processes are excluded, the two other integrals in the previous energy balance of the system can be explained as:

$$dt \int \int \int \overline{E} \frac{{d}^{′} \overline{D}}{dt} dτ = {dW}_{el} + {dW}_{el mec} \\ dt \int \int \int \overline{H} \frac{{d}^{′} \overline{B}}{dt} dτ = {dW}_{m} + {dW}_{m mec} \qquad Equation 009$$

where dWₑₗ is the infinitesimal increase of the electric field energy, dWₘ is the infinitesimal increase of the magnetic field energy, dW_{el mec} the infinitesimal work of the electric field forces and dW_{m mec} the infinitesimal work of the magnetic field forces when the carriers are displaced with displacements δ [symbol] .

If such displacements are, as a preparatory measure, excluded: δĪ=0, therefore ∂/∂t everywhere in place of d′/dt, yields:

$${dW}_{el} = dt \int \int \int \overline{E} \frac{\partial \overline{D}}{\partial t} dτ = dt \int \int \int \frac{\partial w}{\partial t} el dτ \\ {dW}_{m} = dt \int \int \int \overline{H} \frac{\partial \overline{B}}{\partial t} dτ = dt \int \int \int \frac{\partial w}{\partial t} m dτ . \qquad Equation 010$$

### Herein

$${w}_{el} = {\int }_{o}^{D} \overline{E} ( D ) d \overline{D} \qquad Equation 011$$

means the spatial density of the electrical density and

$${W}_{m} = {\int }_{O}^{B} \overline{H} ( B ) d \overline{B} \qquad Equation 012$$

the spatial density of the magnetic field energy.
The field energies are therefore determined by:

$${W}_{B 1} = \int \int \int {\int }_{O}^{D} \overline{E} ( D ) d \overline{D} d τ \\ {W}_{m} = \int \int \int {\int }_{O}^{B} \overline{H} ( B ) d \overline{B} d τ . \qquad Equation 013$$

If displacements δl̅ occur as a consequence of the field forces, the determination of dW _{el mec} and dW_{m mec} must be based on the assumptions that

the scalar μ.

the magnetization vector M̅

the spatial current density vector J̅

adhere to the matter. Ergo
dμ=0 for a constant H

d∫∫M̅ dĀ′=0

d∫∫J̅ dĀ′=0 Equation 014,

where Ā′ designates an area determined in the matter.

With respect to μ, this approach means to neglect the small changes that μ, Ix experiences by the change of the form of a body element, and therefore the small forces of the magnetostriction. With respect to M, this expresses a fact.

With respect to J̅, it is a calculation rule; the actual process can be divided into two parts:

displacement of the matter together with flow adhering thereto

displacement of the flow in relation to the matter.

In the first part of the process, only the change of Vₘ is included in the calculation. These assumptions do now apply for all further considerations. The same considerations can then be applied to the electric field.

In Equations 009, dWₑₗ and dWₘ must definitely be the expressions found in Equations 010 through 013. This yields:

$$d {W}_{e 1 mec} = dt \int \int \int \overline{E} \frac{d \overline{D}}{dt} d τ - d \int \int \int {\int }_{O}^{D} \overline{E} d \overline{D} d τ \\ d {W}_{m mec} = dt \int \int \int \overline{H} \frac{d \overline{B}}{dt} d τ - d \int \int \int {\int }_{O}^{B} \overline{H} d \overline{B} d τ \qquad Equation 015$$

Calculating this yields

$$d {W}_{e 1 mec} = d \int \int \int {\int }_{O}^{E} \overline{D} ( E ) d \overline{E} d τ \\ d {W}_{m mec} = d \int \int \int {\int }_{O}^{H} \overline{B} ( H ) d \overline{H} d τ \qquad Equation 016$$

Analogous to the field energies Wₑ and Wₘ, this becomes

Vₑₗ=∫∫∫vₑₗdτ

Vₘ=∫∫∫vₘdτ

with

$${V}_{e 1} = {\int }_{O}^{E} \overline{D} ( E ) d \overline{E} \\ {V}_{m } = {\int }_{O}^{H} \overline{B} ( H ) d \overline{H} \qquad Equation 017$$

wherein Vₑₗ designates the electric force function, Vₘ the magnetic force function, since the field forces occurring during the displacement of material bodies are calculated from these functions via dVₑₗ=dWel mes, dVₘ=dW_{m mec}. For Wₑₗ, Vₑₗ on the one hand, Wₘ, Vₘ on the other hand,

Wₑₗ+Vₑₗ=∫∫∫Ē·D̅dτ

Wₘ+Vₘ=∫∫∫H̅·B̅dτ Equation 018

applies.

If the thermal losses are, in the energy balance, Pₜₕ dt=0 in Equation 007, the increase of work of the field forces must, according to the law of conservation of energy for a closed system dW_{el mes}, equal the decrease of the field energies.

dW_{el mec}=−dWₑₗ

dW_{m mec}=−dWₘ Equation 019.

dW_{el mec}=−dVₑₗ

dW_{m mec}=−dVₘ Equation 020

becomes, if ε=const, μ=const

dW_{el mec}=dWₑₗ

dW_{m mec}=dWₘ Equation 021

The work is as great as the increase in field energy: if energy is supplied to the not closed system from the outside, the excess is, through the energy loss due to the Joule effect, equally divided between the work of the field forces and the increase in the field energies. Based on the derived energy balance (Equation 20) and the preconditions thereof, the mechanical forces of magnetic origin in the stationary magnetic field are determined using the principle of the virtual displacement. The mechanical work that is applied as a consequence of the field forces during the displacement of bodies can be calculated from the force function.

$$\partial {W}_{mec} = \partial \int \int \int {\int }_{O}^{H} \overline{B} d \overline{H} d τ \qquad Equation 022$$

If displacements occur in a constant external magnetic field (FIG. 4), it must be considered that the permeability μ in the fixed point in space changes despite the constant field H̅.

### Designating

the change in the fixed point in space with ∂

the change in the fixed substantial point with d

the infinitely small displacement with aδ [symbol] ,

this yields, purely geometrically, for a scalar u,

du=∂u+δ [symbol] grad u Equation 023

and, for a vector Ū, the expression already used in Equation 003

$$lim \frac{1}{A} , d \int \int \overline{U} d \overline{{A}^{′}} = {d}^{′} \overline{U} d \overline{{A}^{′}} \qquad Equation 024$$

with

d′Ū=∂Ū+δ [symbol] div Ū+rot [Ūδl̅] Equation 025

With the assumptions in (Equations 003-007) and

div J̅=0 Equation 026

because quasi-stationary processors were assumed, this yields

0=∂μ+δ [symbol] grad μ

0=∂M̅+δ [symbol] div M̅+rot[M̅, δl̅]

0=∂J̅+0+rot[J̅, δl̅] Equation 027

If the magnetic field force H̅ is constant, this yields

∂B̅=∂μ_{|H=const}H̅+∂M̅ Equation 028.

With

div B̅=0

B̅=rot V̅,

the mechanical work can now be calculated by

$$\partial {W}_{mec} = \int \int \int \{ \overline{B} \partial \overline{H} + \overline{H} \partial \overline{M} + {\int }_{O}^{{H}^{′} = H} \partial μ {\vert}_{H = const } {H}^{′} \partial {H}^{′} \} d τ \qquad Equation 029$$

For the first term in the volume integral, this yields

$$\begin{matrix}\int \int \int \overline{B} \partial \overline{H} d τ = \int \int \int rot \overline{V} \partial \overline{H} d τ \\ = \int \int \int \overline{V} \partial \overline{J} d τ \\ = \int \int \int \overline{V} rot [ δ \overline{l} , \overline{J} d τ \\ = \int \int \int δ \overline{l} , [ \overline{J} , \overline{B} ] d τ\end{matrix} \qquad Equation 030$$

The third term becomes

$$\int \int \int {\int }_{O}^{{H}^{′} = H} \partial μ {\vert}_{H = const} {H}^{′} \partial {H}^{′} d τ = - \int \int \int δ \overline{l} {\int }_{O}^{{H}^{′} = H} grad μ {H}^{′} {dH}^{′} d τ \qquad Equation 031$$

If the second term of the volume integral is simplified

$$\begin{matrix}\int \int \int \overline{H} \partial \overline{M} d τ = - \int \int \int \overline{H} \{ δ \overline{l} div \overline{M} + rot [ \overline{M} , δ \overline{l} ] \} d τ \\ = - \int \int \int \{ δ \overline{l} div \overline{M} + rot \overline{H} [ \overline{M} , δ \overline{l} ] d τ \\ = - \int \int \int \{ δ \overline{l} div \overline{M} + δ \overline{ l} [ \overline{J} , \overline{M} ] \} d τ\end{matrix} \qquad Equation 32$$

and then added, this yields

δW_{mec}=∫∫∫f̅ δ [symbol] dτ. Equation 033

with

$$\overline{f} = [ rot \overline{H} , μ \overline{H} ] + \overline{H} div μ \overline{H} - {\int }_{O}^{{H}^{′} = H} grad μ {H}^{′} {dH}^{′} \qquad Equation 34$$

which describes the force in relation to the volume unit.

This force is composed of three portions:

a force acting upon current carriers [J̅, μH̅]

a force acting upon carriers of magnetic quantities H̅·ρₘ

a force also acting upon bodies not subject to flow and upon non-permanent magnetic bodies, but on bodies the magnetic behavior of which differs from their environment.

The establishment of an energy balance is based on the principle of the virtual displacement. This requires an energy balance in the not closed system.

δW_{mec}=δV Equation 035

If the armature of the electromagnet (FIG. 11) is now displaced by a small amount δₓ, while the current I in the winding is kept constant, the magnetic flux Φ in the yoke, core, armature and air gap increases by an amount of δΦ and the magnetic flux density B₂ by an amount of δB₂,

δΦ=A δB₂ Equation 036

This induces a source voltage in the electric circuit. In order to overcome this source voltage, the coil must be supplied with the electric work

δWₑₗ=(H₂l₂+H₁l₁)A δB₂ Equation 037.

The magnetic energy stored in the soft iron core is

$$A {1}_{2} {\int }_{O}^{{B}_{2}} H d B \qquad Equation 038$$

During the displacement, it increases by the amount of

$$A {1}_{2} {\int }_{{B}_{2}}^{{B}_{2} + {δB}_{2}} H d B = A {1}_{2} {H}_{2} δ {B}_{2} \qquad Equation 039$$

As a consequence of the extension δₓ, the inner energy increases by the amount of

$$A δ x {\int }_{O}^{{B}_{2}} H d B = A δ x \frac{{μ}_{2} {H}_{2}^{2}}{2} \qquad Equation 040$$

In the air gap, the stored energy is increased due to the increase of B₁ and δB₁ (B₁=B²) and decreased due to the diminution of the air gap by δₓ. In total, the energy stored in the core and in the air gap increases by

$$δ W = A {1}_{2} {H}_{2} δ {B}_{2} + A δ x \frac{{μ}_{2} {H}_{2}^{2}}{2} + A {1}_{1} {H}_{1} δ {B}_{1} - A δ x \frac{{B}_{1}^{2}}{2 {μ}_{1}} \qquad Equation 041$$

Eventually, during the displacement, the mechanical work

δW_{mec}=P A δₓ Equation 042

is applied. The energy balance

δWₑₗ=δW+δW_{mec} Equation 043

yields

$$( {H}_{2} {1}_{2} + {H}_{1} {1}_{1} ) A δ {B}_{2} = A {1}_{2} {H}_{2} δ {B}_{2} + A δ x \frac{{B}_{2}^{2}}{2 {μ}_{2}} + A {1}_{1} {H}_{1} δ {B}_{1} - A δ x \frac{{B}_{1}^{2}}{2 {μ}_{1}} + p A δ x \qquad Equation 044$$

This results in

$$p = \frac{{B}_{1}^{2}}{2 {μ}_{1}} - \frac{{B}_{2}^{2}}{2 {μ}_{2}} , \qquad Equation 045$$

wherein the specific area force p equals, at an interface between materials having different permeabilities, the difference of the energy densities in these permeable substances. The energy division in the electromagnet and in the permanent magnet is considered under these limiting assumptions. It should be noted that in the permanent magnet, the inner energy has a larger influence on the force than in the electromagnet. In order to investigate this energy division, the same hypotheses are assumed as described in the beginning for a small air gap. For a permanent magnetic core, it is, in general observations regarding energy, following the state of science and art, common to differ between inner (index i) and outer (index e) energy (FIG. 5).

### For FIG. 5

[symbol] H̅ d [symbol] =Θ

div B̅=0

B̅=μH̅+M̅ Equation 046

applies.

A comparison of the electromagnet and the permanent magnet shows the present composition of the field strengths:

Equation 047

| Electromagnet | Permanent magnet |
|---|---|
| M̅ = 0 , μᵣ = const | M̅ = const, μᵣ = const |
| B̅ = μH̅ | B̅ = μH̅ + M̅ |
| [symbol] H̅ dl̅ = Θ_{b} | [symbol] H̅ dl̅ = 0 |
| H_{B}l_{B} + Hᵢlᵢ = Θ_{b} | H_{B}l_{B} + Hᵢlᵢ = 0 (1.8-4) |
| div B̅ = 0 | div B̅ = 0 |
| μₒHₑ = μₒμᵣHᵢ | μₒHₑ = μᵣμₒHᵢ + M (1.8-5) |

This yields the external and the internal magnetic field strength with

$$\begin{matrix}x = {1}_{e} / {1}_{i} \\ {H}_{e} = \frac{{μ}_{r} {Θ}_{b}}{{1}_{i}} \frac{1}{( 1 + {μ}_{r} x )} \\ {H}_{e} = \frac{M}{{μ}_{o}} \frac{1}{( 1 + {μ}_{r} x )} \\ & Equation 048 \\ {H}_{i} = \frac{{Θ}_{b}}{{1}_{i}} \frac{1}{( 1 + {μ}_{r} x )} \\ {H}_{i} = - \frac{M}{{μ}_{o}} \frac{x}{( 1 + {μ}_{r} x )} & Equation 049\end{matrix}$$

The air gap energy (external)

$$\begin{matrix}{W}_{e} = \frac{1}{2} {μ}_{o} {H}_{e}^{2} A {1}_{e} & Equation 050 \\ {W}_{e} = \frac{{μ}_{r} {μ}_{o} A}{{21}_{i}} {Θ}_{b}^{2} \frac{{μ}_{r} x}{{( 1 + {μ}_{r} x )}^{2}} \\ {W}_{e} = \frac{{M}^{2} {1}_{i} A}{2 {μ}_{r} {μ}_{o}} \frac{{μ}_{r} x}{{( 1 + {μ}_{r} x )}^{2}} \\ & Equation 051\end{matrix}$$

and

Electromagnet Permanent magnet

The internal energy

W₁=1/2μᵣμₒHᵢ²Alᵢ Equation 052

with

$${W}_{i} = \frac{{μ}_{r} {μ}_{o} A}{2 {1}_{i}} {Θ}_{b}^{2} \frac{1}{{( 1 + {μ}_{r} x )}^{2}} \\ {W}_{i} = \frac{{M}^{2} {1}_{i} A}{2 {μ}_{r} {μ}_{o}} \frac{{μ}_{r} x}{{( 1 + {μ}_{r} x )}^{2}} \qquad Equation 053$$

The total energy (external and internal)

$$\begin{matrix}W = {W}_{i} + {W}_{e} & Equation 054 \\ {W}_{b} = \frac{{μ}_{r} {μ}_{o} A}{2 {1}_{i}} {Θ}_{b}^{2} \frac{1}{( 1 + {μ}_{r} x )} \\ {W}_{a} = \frac{{M}^{2} {1}_{i} A}{2 {μ}_{r} {μ}_{o}} \frac{{μ}_{r} x}{( 1 + {μ}_{r} x )} & Equation 055\end{matrix}$$

The different expressions are now represented by the magnetic permeances

$${Λ}_{i} = \frac{{μ}_{o} {μ}_{r} A}{{1}_{i}} , {Λ}_{e} = \frac{{μ}_{o} A}{{1}_{e}} \\ {H}_{e} = \frac{1}{{μ}_{o} A} \frac{{Λ}_{e} {Λ}_{i}}{( {Λ}_{e} + {Λ}_{i} )} {Θ}_{b} \\ {H}_{e} = \frac{1}{{μ}_{o} A} \frac{{Λ}_{e} {Λ}_{i}}{( {Λ}_{e} + {Λ}_{i} )} {Θ}_{a} \\ {H}_{i} = - \frac{1}{{μ}_{{ }_{r}} {μ}_{o} A} \frac{{Λ}_{e} {Λ}_{i}}{( {Λ}_{e} + {Λ}_{i} )} {Θ}_{b} \\ {H}_{i} = \frac{1}{{μ}_{{ }_{r}} {μ}_{o} A} \frac{{Λ}_{i}^{2}}{( {Λ}_{e} + {Λ}_{i} )} {Θ}_{a} \\ {W}_{e} = \frac{1}{2} \frac{{Λ}_{e} {Λ}_{i}^{2}}{{( {Λ}_{e} + {Λ}_{1} )}^{2}} {Θ}_{b}^{2} \\ {W}_{e} = \frac{1}{2} \frac{{Λ}_{e} {Λ}_{i}^{2}}{{( {Λ}_{e} + {Λ}_{i} )}^{2}} {Θ}_{a}^{2} \\ {W}_{i} = \frac{1}{2} \frac{{Λ}_{e}^{2} {Λ}_{i}}{{( {Λ}_{e} + {Λ}_{i} )}^{2}} {Θ}_{b}^{2} \\ {W}_{i} = \frac{1}{2} \frac{{Λ}_{i}^{3}}{{( {Λ}_{e} + {Λ}_{i} )}^{2}} {Θ}_{a}^{2} \\ {W}_{b} = \frac{1}{2} \frac{{Λ}_{e} {Λ}_{i}}{( {Λ}_{e} + {Λ}_{i} )} {Θ}_{b}^{2} , \\ {W}_{a} = \frac{1}{2} \frac{{Λ}_{i}^{2}}{( {Λ}_{e} + {Λ}_{i} )} {Θ}_{a}^{2} \\ {Θ}_{b} = NI \\ {Θ}_{a} = {H}_{o} {1}_{i} , {H}_{o} = \frac{M}{{μ}_{o} {μ}_{r}} \qquad Equation 056$$

The plot (FIG. 6) alone already shows the strong influence of the inner energy density in the permanent magnet, while it is negligible in the electromagnet If the Maxwell stress tensor is applied to one of the interfaces of the magnet, the differences of the fictive stresses are formed on the left side and on the right side of the interface in order to determine the observable force. The following expression results for the force:

F̅=∫∫(p̅ₑ−p̅ᵢ)dA

p̅ₑ−p̅ᵢ=(1/2μₒH_{B}²−1/2μₒμᵣHᵢ²)n̅, Equation 057

because only normal components of the magnetic field strengths were assumed. The magnetic field strengths are now replaced by the quantities of the current source equivalent circuit diagram. An integration over the partial area yields the force:

$$F = \frac{{Λ}^{2} {Θ}_{a}^{2}}{2 {μ}_{o} A} \{ 1 - {{μ}_{r} ( \frac{{1}_{e}}{{1}_{i}} )}^{2} \} \qquad Equation 058$$

Corresponding considerations for the electromagnet yielded:

$$F = \frac{{Λ}^{2} {Θ}_{b}^{2}}{2 {μ}_{o} A} \{ 1 - \frac{1}{{μ}_{r}} \} \qquad Equation 058$$

Following the state of science and art, Equation 058 includes a “correction teen”, which depends exclusively on the geometric dimensions of the air gap μᵣ and the length of the permanent magnet. Following the state of science and art, the forces superpose without mutually influencing each other. To explain this, the permanent magnet is surrounded by a coil supplied with current (FIG. 7). The coil is excited in a mariner that the field of the permanent magnet and the field of the coil in the air gap are aligned. The following applies:

[symbol]

H̅d [symbol] =Θ

div B̅=0

B̅=μH̅+M̅ Equation 060

The field equations for the normal components of the magnetic field strength are

[symbol]

H̅d [symbol] =Θ_{b}

θ_{b}=H_{B}l_{B}+Hᵢlᵢ

div B̅=0

μₒHₑ=μᵣμₒHᵢ+M Equation 061

This yields the external and the internal magnetic field strength with x=lₑ/lᵢ

$${H}_{e} = \frac{1}{( 1 + {μ}_{r} x )} ( \frac{{μ}_{r} {Θ}_{b}}{{1}_{i}} + \frac{M}{{μ}_{o}} ) \\ {H}_{i} = \frac{1}{( 1 + {μ}_{r} x )} ( \frac{{Θ}_{b}}{{1}_{i}} + \frac{M}{{μ}_{o}} x ) \qquad Equation 062$$

A comparison according to the state of science and art shows:

The partial fields resulting from the coil (Θ_{b}) and the partial fields resulting from the permanent magnet (M) superpose without mutually influencing each other: For the air gap energy (external) this yields, following the state of science and art, the following expression

$${W}_{e} = \frac{1}{2} {μ}_{o} {H}_{e}^{2} A {1}_{e} \\ {W}_{e} = \frac{1}{2} \frac{{μ}_{o} A {1}_{i}}{2 {( 1 + {μ}_{r} x )}^{2}} \times {[ \frac{{μ}_{r} {Θ}_{b}}{{1}_{i}} + \frac{M}{{μ}_{o}} ]}^{2} \qquad Equation 063$$

The internal energy can then be calculated as follows:

$${W}_{1} = \frac{1}{2} {μ}_{r} {μ}_{o} {H}_{1}^{2} A {1}_{i} \\ {W}_{1} = {\frac{{μ}_{r} {μ}_{o} {1}_{i} A}{2 {( 1 + {μ}_{r} x )}^{2}} [ \frac{{Θ}_{b}}{{1}_{i}} - \frac{M}{{μ}_{o}} x ]}^{2} \qquad Equation 064$$

This yields, following the state of science and art, the total energy (external+internal)

$$W = {W}_{i} + {W}_{e} \\ W = \frac{A}{2 ( 1 + {μ}_{r} x )} [ \frac{{μ}_{r} {μ}_{o} {Θ}_{b}^{2}}{{1}_{i}} + \frac{x {1}_{i} {M}^{2}}{{μ}_{o}} ] \qquad Equation 065$$

and as magnetic permeances:

$${H}_{e} = \frac{1}{{μ}_{o} A} \frac{{Λ}_{e} {Λ}_{i}}{{Λ}_{e} + {Λ}_{i}} [ {Θ}_{b} + {Θ}_{a} ] \\ {H}_{1} = \frac{1}{{μ}_{{ }_{r}} {μ}_{o} A} \frac{{Λ}_{e} {Λ}_{i}}{{Λ}_{e} + {Λ}_{i}} [ {Θ}_{b} - \frac{{Λ}_{i}}{{Λ}_{e}} {Θ}_{a} ] \\ {W}_{e} = \frac{1}{2} {\frac{{Λ}_{e} {Λ}_{i}^{2}}{{( {Λ}_{e} + {Λ}_{i} )}^{2}} [ {Θ}_{b} + {Θ}_{a} ]}^{2} \\ {W}_{i} = \frac{1}{2} {\frac{{Λ}_{e}^{2} {Λ}_{i}}{{( {Λ}_{e} + {Λ}_{i} )}^{2}} [ {Θ}_{b} - \frac{{Λ}_{i}}{{Λ}_{e}} {Θ}_{a} ]}^{2} \\ W = \frac{1}{2} \frac{{Λ}_{e} {Λ}_{i}}{( {Λ}_{e} + {Λ}_{i} )} [ {Θ}_{b}^{2} + \frac{{Λ}_{i}}{{Λ}_{e}} {Θ}_{a}^{2} ] \qquad$$

and therefore

$$W = \frac{1}{2} \frac{{Λ}_{e} {Λ}_{i}}{( {Λ}_{e} + {Λ}_{i} )} \cdot ( {Λ}_{i} \text{/} {Λ}_{e} {Θ}_{a}^{2} + {Θ}_{b}^{2} + O ) \qquad Equation 066$$

From a comparison with Equation 065, the state of science and art concludes that the total energy of the combined field equals the sum of the individual energy amounts which result from first taking M=0 and then Θ_{b}=0.

There is no reciprocal energy between the coil and the permanent magnet. To clearly represent the reciprocation of this electromechanical system in an equivalent circuit diagram (FIG. 8), the energy balance requires a combination of a voltage source equivalent circuit diagram for the electric circuit and a current source equivalent circuit diagram for the permanent magnet. The energy division of the permanent magnet and the electromagnet alone are also included therein as special cases. In the known equivalent circuit diagram (FIG. 8), the following applies for a reciprocal energy:

$$\begin{matrix}W = \frac{1}{2} {Λ ( {Θ}_{a} + {Θ}_{b} )}^{2} \\ = \frac{1}{2} Λ ( {Θ}_{a}^{2} + {Θ}_{b}^{2} + 2 {Θ}_{a} {Θ}_{b} )\end{matrix} \qquad Equation 068$$

This is mentioned in “Analyse von variablen Reluktanzsystemen anhand von Integralgleichungen”, page 48. Fischer also teaches in “Abriss der Dauermagnetkunde”, page 80, an energy balance and concludes, like Remus, that, due to a lack of reciprocal influence of the electromagnetic and the permanent magnet, the last term 2ΘₐΘ_{b} of the energy balance can be neglected, as it becomes=0.

This tern is also neglected by Multon in “ENS Cachan—Antenne de Bretagne “Application des aimants aux machines electriques”, page 6, 2005.

The object underlying the invention is to provide a more precise calculation method for designing reluctance systems. This object is met according to claim 1 by providing a calculation method for designing reluctance systems by balancing the inner and outer system energy using the equation W=1/2Λ(Θ₂²+Θ_{b}²+2ΘₐΘ_{b}), where 2ΘₐΘ_{b}≠0.

Designing herein refers to: the dimensioning of the permanent magnet (length, height, width, shape), the choice of materials, the dimensioning of the electromagnet consisting of coil and core (length, height, width, shape, number of turns, coil conductor thickness, choice of materials), the dimensioning of the air gap (positioning of the permanent magnet and the electromagnet with respect to each other), supplying the electromagnet with current, wherein

$${Θ}_{a} = \frac{{B}_{R}}{{μ}_{0} {μ}_{r}} {l}_{i}$$

is the magnetomotive force of the permanent magnet and

Θ_{b}=N I

is the magnetomotive force of the electromagnet and Λ is the permanency. In contrary to the state of science and art, Hₑ and Hᵢ behave in accordance with:

$${H}_{e} = \frac{1}{{μ}_{0} A} \frac{{Λ}_{e} {Λ}_{i}}{( {Λ}_{e} + {Λ}_{i} )} \cdot ( {Θ}_{a} + {Θ}_{b} )$$

$${H}_{i} = \frac{1}{{μ}_{0} {μ}_{r} A} \frac{{( {Λ}_{i} )}^{2}}{( {Λ}_{e} + {Λ}_{i} )} \cdot ( {Θ}_{a} + {Θ}_{b} )$$

$${W}_{e} = \frac{1}{2} \frac{{Λ}_{e} {Λ}_{i}^{2}}{{( {Λ}_{e} + {Λ}_{i} )}^{2}} \cdot {( {Θ}_{a} + {Θ}_{b} )}^{2}$$

$${W}_{i} = \frac{1}{2} \frac{{Λ}_{i}^{3}}{{( {Λ}_{e} + {Λ}_{i} )}^{2}} \cdot {( {Θ}_{a} + {Θ}_{b} )}^{2}$$

$$W = \frac{1}{2} \frac{{Λ}_{i}^{2}}{( {Λ}_{e} + {Λ}_{i} )} \cdot {( {Θ}_{a} + {Θ}_{b} )}^{2}$$

$$W = \frac{1}{2} \frac{{Λ}_{i}^{2}}{( {Λ}_{e} + {Λ}_{i} )} \cdot ( {Θ}_{a}^{2} + {Θ}_{b}^{2} + 2 {Θ}_{a} {Θ}_{b} )$$

Contrary to the state of science and art, the second term of the energy balance 2ΘₐΘ_{b} is included in the calculation. In many publications regarding measuring technology, it is pointed out that there is a certain relation between the length of the air gap and the length of the permanent magnet. In order to be able to approximately calculate the force anyway, “a correction factor” an increase of the stray factor was introduced. In doing so, the stray fluxes are assumed too large, as this had already been seen with anisotropic materials. The illustration of the magnetization characteristic B as a function of H illustrates the geometric relationships (FIG. 10).

The shear straight 2 connects the zero point with the point of the magnetization characteristic of the permanent magnet for I=0. This yields the intersection point 3, which is referred to as the working point. The zero point (B/H), the working point 3 and the intersection point of the magnetization line 1 with the ordinate B span a triangle. This triangle describes the external energy (density) of the permanent magnet. Added thereto is now the external energy (density) of the electromagnet, which, however, influences the total energy of the permanent magnet such that the total energy of the reluctance system consisting of the total energy of the permanent magnet and the total energy of the electromagnet increases by the amount of 2ΘₐΘ_{b}. These are the two parallelograms with the width between the points 4 and 5, wherein 6 is the new working point of the reluctance system and 7 is the value offset by Θ_{b}/lᵢ on the abscissa H. FIG. 10 shows that this results in two parallelograms 2ΘₐΘ_{b} spanning the area 2ΘₐΘ_{b}. This was also confirmed by the measurement results (FIG. 11).

According to a preferred calculation variant, the magnetic potential of an electromagnet Θ_{b}, which is a value that depends on the current (I), is chosen such that

W=1/2Λ(Θₐ²+Θ_{b}²+2ΘₐΘ_{b})=becomes minimal≧1.

and the following calculation steps are carried out:
using an initial value with I=O and a second value I₁ ranging between I=0 and I=I_{Sättigung} for Θ_{b};
calculating an evaluation value B₁, which is a measure for leveling the balancing between Θₐ and Θ_{b} with W=1/2Λ(Θₐ²+Θ_{b}²+2ΘₐΘ_{b}),
calculating a second evaluation value B₂ for I₂ with the assumption I₁<I₂<I_{Sättigung} for Θ_{b};
with B₂<B₁, taking B₂ as a new evaluation standard.

The objective of such a calculation is to calculate the working point at which

W=½Λ(Θₐ²+Θ_{b}²+2ΘₐΘ_{b}) becomes minimal≧1.

(FIG. 11) Minimal herein means a value approaching 1. The evaluation value is any value that increases if the sum of the energy balance increases. This may for example be done by multiplying one of the values by a random number or by adding a value to at least one of the values (I). The extent of the change is proportional to the evaluation value and inversely proportional to the number of changes such that the optimization of the evaluation pattern is almost completed after a multitude of changes. The relevant change of the excitation happens at the beginning of the optimization process. A fast changing evaluation value delays the end of the optimization, but may, however, also resume the almost completed optimization process. If the evaluation value is ideally at a minimum, the energy balance approaches 1 and no further calculation is carried out. The working point of a corresponding system was, following the state of science and art, determined by the point that is the intersection point of the shear straight and the magnetization characteristic of the permanent magnet, assuming that I=0. Considering 2ΘₐΘ_{b}, the working point is now not searched for on the magnetization characteristic but on the shear straight.

According to a further preferred embodiment, prior to the energy balancing described, the following steps are carried out.
a) inputting the data of the reluctance system partners,
b) determining the magnetic resistances as a function of the input data,
c) outputting the values of the values obtained in step b) as spline functions,
d) determining the magnetic intermediate range reluctances,
e) establishing at least one non-linear equation system with the values generated in steps b) through d),
f) leveling the nonlinearity of the equation system according to step e) by means of a mathematical model.

ψ̅(αn)φ̅(αn)R̅mag(αn)

in order to obtain the output values

If a reluctance system partner is for example composed of an electromagnet having a teeth structure, according to the integral equation method, the equivalent magnetic permeance or the attractive force and push force, respectively, are known for a specific position. In order to obtain intermediate values from these ordered values pairs, an interpolation is required. A comparison with other interpolation methods shows that interpolation by means of spline functions offers significant advantages. Interpolation in a narrower sense means the reconstruction of a function f(x) from values f(xi), which are given on discrete points xi. From the technical definition of the problem, it results in general that there must be a continuous function f(x), for which f(xi)=fᵢ applies. Since f(x) is now, except for the support values fi, unknown, one looks for a relatively “simple” function,

for which f(xi)=fi applies at the supporting points.

While the error R(x)=\tilde{f}(x)=f(x) disappears at the supporting points xi, no general conclusion can be made about its course in the interval [a, b]. It is therefore assumed that the unknown function f(x) approaches \tilde{f} in [a, b].

The determination of values \tilde{f}(x) for arguments x∈[a, b], x≠xᵢis referred to as interpolation. From a function f(x), the analytic form of which is not known, the support values fᵢ thereof are in the interval [a, b] given at finitely many supporting points xᵢ in a Cartesian coordinate system.

This is based on the definition that xi increases in a monotonous manner. One possibility of connecting these supporting points by an often differentiable smooth curve is the always existing LAGRANGE interpolation polynomial

$$P ( x ) = {\sum }_{k = 0}^{N} {L}_{k} ( x ) {f}_{k} {L}_{k} ( x ) = {\prod }_{i = 0 \\ i \neq k}^{N} \frac{( x - {x}_{i} )}{( {x}_{k} - {x}_{i} )} \qquad Equation 069$$

or also the algebraic polynomial

$$P ( x ) = {\sum }_{i = 1}^{N} {c}_{i - 1} {x}^{i - 1} \qquad Equation 070$$

However, these polynomials vary with an increase in number and with the selection of the supporting points. On the other hand, the smallest possible polynomial degree between two points is the polygonal chain. The variation of the interpolation function is minimal, while the unsteadiness at the node already starts, however, in the first derivation; furthermore, these curves are not smooth, as shown in FIG. 14. A compromise between the polygonal chain and the interpolation polynomial of a higher order is especially advantageous: in doing so, low-order and thus weakly varying polynomials are linked to a function possibly often differentiable in the entire interval [a, b]. The application of the rational spline function shows the edge effects and longitudinal effects occurring in a linear motor (FIG. 15).

When designing a corresponding reluctance system, it is especially advantageous to level the occurring nonlinearities by a mathematical model.

When applying the integral equation method, it is therefore presupposed that the boundary conditions are known and the space to be looked at is linear. In the cases considered, this space is represented by the air gap zone. The edge is formed by the stator and rotor surfaces. On the surfaces, the

### Ditrichlet

u[x]=f[x]

### Neumann

$$\frac{\partial u ( x )}{\partial n} = f ( x ) \qquad Equation 071$$

boundary conditions must be specified. The following applies in general:

$$Au ( x ) + B \frac{\partial u ( x )}{\partial n} + C \frac{\partial u ( x )}{\partial t} = f ( x ) \qquad Equation 072$$

Since the stator and rotor consist, in the considered cases, of ferromagnetic materials, the surfaces are, from the outset, to be considered as “nonlinear edges”. This means that the boundary conditions to be specified depend on the saturation state. Preferably, in the course of a calculation method, the nonlinearity of the equation system is leveled by using the derived stress tensor

\vec{p}=−∫ₒ^{H′=H}μH′dH′+μHₓ²; μHₓH_{y}; μHₓH_{z}.

In order to theoretically detect the nonlinearities, the derived stress tensor for nonlinear material functions of the relationship

$${P}_{xx} = - {\int }_{0}^{{H}^{′} = H} μ {H}^{′} {dH}^{′} + μ {H}_{x}^{2} ; {p}_{xy} = {p}_{yx} = {μH}_{y} {H}_{x} \\ {P}_{yy} = - {\int }_{0}^{{H}^{′} = H} μ {H}^{′} {dH}^{′} + μ {H}_{y}^{2} ; {p}_{xz} = {p}_{zx} = {μH}_{x} {H}_{z} \\ {P}_{zz} = - {\int }_{0}^{{H}^{′} = H} μ {H}^{′} {dH}^{′} + μ {H}_{z}^{2} ; {p}_{zy} = {p}_{yz} = {μH}_{y} {H}_{z} \qquad Equation 073$$

is used as a basis.

The following applies:

$$Equation 074 \\ \overline{p} = \begin{matrix}\begin{matrix}- {\int }_{0}^{{H}^{′} = H} μ {H}^{′} {d}^{′} H + \\ μ {H}_{x}^{2}\end{matrix} & μ {H}_{x} {H}_{y} & μ {H}_{x} {H}_{z} \\ μ {H}_{y} {H}_{x} & \begin{matrix}- {\int }_{0}^{{H}^{′} = H} μ {H}^{′} {dH}^{′} + \\ μ {H}_{y}^{2}\end{matrix} & μ {H}_{y} {H}_{z} \\ μ {H}_{z} {H}_{x} & μ {H}_{z} {H}_{y} & \begin{matrix}- {\int }_{0}^{{H}^{′} = H} μ {H}^{′} {dH}^{′} + \\ μ {H}_{z}^{2}\end{matrix}\end{matrix} \qquad$$

With this tensor p, the fictive stress state in the nonlinear medium can be described as follows: each unit area extending perpendicularly to the field H is, along the field lines, acted upon by a normal tension in the amount of:

$$\vert \overline{p} \vert = μ {H}^{2} - {\int }_{0}^{{H}^{′} = H} μ {H}^{′} {dH}^{′} \\ L = \vert \overline{p} \vert = {\int }_{0}^{{H}^{′} = H} {H}^{′} d ( μ {H}^{′} ) , \qquad Equation 075$$

and each area unit extending parallel to the field H is acted upon, transversely to the field lines, by a normal pressure in the amount of:

$$Q = \vert \overline{p} \vert = {\int }_{0}^{{H}^{′} = H} μ {H}^{′} {dH}^{′} . \qquad Equation 076$$

In the usual nonlinear magnetization functions, the lateral pressure is therefore always greater than the longitudinal tension (FIGS. 16, 17), that means the tensile stresses and the compressive stresses differ from each other.

L+Q=BH

wherein L is the magnetic energy density w and Q is the magnetic force density function v.

w+v=BH

Everywhere the magnetization function is linear,

w=v=1/2μH²

applies, wherein the fictive magnetic tensile stresses and compressive stresses are only equal in case of a straight-line magnetization function. If an area—of random length—is randomly placed in the magnetic field H with the area unit normal n, the stress tensor p can be represented by different expressions:

$$\begin{matrix}\overline{p} = ( μ \overline{H} , \overline{n} ) \overline{H} - v \overline{n} \\ = [ μ \overline{H} , [ \overline{H} , \overline{n} ] ] + w \overline{n} \\ = ( μ \overline{H} , \overline{n} ) [ \overline{n} , [ \overline{H} , \overline{n} ] ] + \overline{n} \{ {w cos}^{2} α - {v sin}^{2} α \}\end{matrix} \qquad Equation 077$$

This applies if α is the angle between the magnetic field strength H and the unit nominal n. The vector diagram (FIG. 18) shows this interrelation. The comparison with the magnetization function, which is assumed to be constant, shows that not only the amount of p changes. The angle β between p and the magnetic field strength H will, in a usual magnetization function, always be greater than the angle α between the magnetic field strength H and the area unit normal n. In order to be able to determine the mechanical stresses of magnetic origin on an interface formed by two bodies having different nonlinear magnetization functions, area-related currents and magnetic area-related charges are excluded.

Since the normal component of the magnetic flux density (B̅, n̅) and the tangential component of the magnetic field strength [H̅, n̅] have the same values on both sides of the interface, this yields as observable force acting upon the unit area:

p̅₂₁=n̅{w₁ cos² α₁−v₁ sin² α₁−w₂ cos² α₂+v₂ sin²α₂} Equation 078,

wherein the observable force acts perpendicularly to the interface, so there is no push. A case in which the body (2) is iron and the body (1) is air yields

p̅₂₁=n̅{1/2μₒH_{J}² cos 2α₁−w₂ cos² α₂+V₂ sin² α₂} Equation 079

If α₂ is not becoming too close to a right angle, w2 and v₂ are small in relation to w₁=v₁ and the first term dominates with w₁, ergo

p̅₂₁≈w₁n̅

If the force lines in the iron impinge on the surface in a grazing manner (α² approximately 90°), the force line density in the iron becomes significantly greater than in the air, w₂ and v₂ therefore become next to w₁=v₁. The field lines in the air then form almost a right angle with the field lines in the iron and the lateral pressure of the field lines in the iron now considerably supports the almost aligned longitudinal tension of the field lines in the air, which longitudinal tension is in usual cases observed alone, (FIG. 20), ergo

p̅₂₁≈(w₁+v₂)n̅

This explains that, in the electromagnet, the tensile forces exceed the expectations that often. The nonlinear magnetization function of the iron causes an increase of the amount of p₂ and of the complementary angle β for this incidence angle α₂. The increase of the amount acts upon the resulting vector p₂₁ in the same direction; it supports it. This is why a greater force or a greater moment can be obtained in saturated materials, which could also be observed in many electromechanical systems. It can be clearly seen that the properties that are fully symmetrical in cases of constant permeability are lost due to the nonlinear magnetization function.

Advantageously, the reluctance system consists of the rotor and stator of an electric motor. The term electric motor of course also encompasses linear motors. Another especially advantageous embodiment is described by a calculation method in which the determination of the intermediate range reluctances is replaced by a determination of the air gap reluctances as a function of the rotor position αₙ, and in which the calculation steps are finally repeated n times with the now obtained values for each rotor position αₙ. By way of example, this is illustrated with a differential reluctance three-phase motor, the cut of the stator sheet metal of which comprises, in FIG. 21, 12 toothed poles with 10 teeth each. The resulting tooth pitch corresponds to an overall teeth number of 132 teeth as the gap between two poles equals a stator tooth pitch. The three-phase winding provided in the stator slots generates, using diodes, a four-pole rotational field.

The cut-out rotor (FIG. 22) having 130 teeth, which neither carries a winding nor a cage, rotates with a synchronous angle velocity of n=23.08 l/min. Due to this specified tooth structure, the rotor angle velocity can be decreased without any additional gear. A motor having these properties is called a differential reluctance motor, for which a common development of the rotor and stator is specified. FIG. 23 shows the partial development of the rotor and the stator. In the air gap zone 1, the teeth of the rotor and the stator are arranged such as to exactly face each other. For this position, the magnetic permeance reaches its maximum value. If the rotor now moves from stator tooth 1 to stator tooth 2, the magnetic axis moves towards the air gap zone 2. The rotor has covered the distance

Δx=τ_{dr}−τ_{ds} Equation 080

while the magnetic axis has further moved around the stator tooth position τ_{ds}. Substituting the tooth number of the rotor Nᵣ and the stator Nₛ in Equation 078, and generating the quotient from the field rotational speed of the magnetic axis and the rotor speed, this yields

$$R = \frac{{N}_{r} - {N}_{s}}{{N}_{r}} \cdot \frac{{n}_{r}}{{n}_{s}} \qquad Equation 081$$

This reduction factor R only depends on the number of the rotor and stator teeth, thereby obtaining a synchronous rotor speed, which represents a fraction of the field rotational speed of the stator.

In order to precisely calculate this differential reluctance motor, the following is assumed:
the material used is homogeneous and isotropic
the permeability in the iron is infinite
the occurring asynchronous torque is negligible
the air gap can be divided into constant air gap zones, on the basis of which the magnetic permeance can be calculated
stray influences are negligible.

The magnetic permeance of each air gap zone is calculated under these conditions; with a zone, hatched in position 4 in FIG. 23, for a specific rotor position, for which the equivalent magnetic permeance can now be calculated according to the integral equation method. In order to obtain the associated analytic expression, these calculated permeances are interpolated by means of a balancing periodic spline function. The measured static torque is represented for different currents as a function of the angle. For I=600 mA, the maximum moment T=14.10 Nm. For the same current, the calculation yields T=15.48 Nm. (FIG. 24)

For the dynamic behavior, the current was measured and calculated. The rotor moves two steps forward. That stationary current is I=600 mA. Therefore, the calculation matches the measurement. (FIG. 25)

According to a preferred variant of the invention, the previous calculation step is, after the calculation of the air gap resistances was repeated n times with the now obtained values for each rotor position αn, through the induced voltage of the electric motor, followed by the determination of the torque thereof. This offers the advantage, in particular for geometrically complex reluctance systems, that all reluctance portions in the calculation are taken into consideration. However, the calculation may also be inverted such as to calculate different possibilities to design the geometry of a reluctance system in a way that the motor achieves the required performance characteristic values. Characteristic performance values refer to the performance and the torque of the motor.

According to a specifically advantageous embodiment, an equivalent circuit diagram, which consists of a combination of a voltage source equivalent circuit diagram and a current source equivalent circuit diagram, is used for ascertaining the spline functions. The equivalent circuit diagram preferably shows the inner and outer energy as well as the total energy; the respective magnetic permeances represent the corresponding energies. Following the state of science and art, it can be seen that the permanent magnetic circuit reflects, as a voltage source equivalent circuit diagram, the inner energy and the total energy balance in a non-complete manner

A corresponding adequate equivalent circuit diagram is shown in FIGS. 27 and 28. Based on the tensile force that is exerted on the one half ring of the permanent magnet, the representation of the energy densities, in relation to the permanent magnet volume, has shown itself to be advantageous in the B(H) diagram in order to be able to compare the energy conditions in the electromagnet and the permanent magnet. For this purpose, Equations (063) through (066) are used and the energies are correlated to the permanent magnet volume.

$${w}_{e} = \frac{{W}_{e}}{{l}_{i} A} \\ {w}_{e} = \frac{1}{2} {B}_{i} {H}_{i} \\ {w}_{1} = \frac{{W}_{2}}{{l}_{i} A} \\ {w}_{i} = \frac{1}{2} ( {B}_{1} - M ) {H}_{i} \\ w = \frac{W}{{l}_{i} A} \\ w = \frac{1}{2} {MH}_{i} \qquad Equation 082$$

These energy densities are shown in FIGS. 29, 30. On the basis of the energy balance in the not closed system and considering the material functions, which are assumed as linear, this yields the diagrams shown in FIGS. 31, 32 for the mechanical work in relation to the magnetic volume. The previously specified object is also met by a computer program having program code means, in particular a computer program stored on a machine-readable medium for carrying out that method according to one of the previous claims when the computer program is executed on a computer. The computer may in particular be a microprocessor or a microcontroller. Correspondingly, the computer program is then a software executed on this computer. The computer program may then be stored in a memory of the microprocessor or the microcontroller. The computer program may also be stored on a different machine-readable medium, for example an exchangeable medium such as a CD-ROM or a memory stick.

The invention is now explained in greater detail by means of examples and the accompanying illustrations. This merely serves to illustrate the invention without limiting its generality.

### BRIEF DESCRIPTION OF THE DRAWINGS

FIGS. 1, 2, 3 show the magnetization functions of the air gap, the soft iron and the permanent magnet.

FIG. 4 shows the change of the permeability despite the external field being constant.

FIG. 5 shows a comparison between the electromagnet and the permanent magnet.

FIG. 6 shows a plot of the mechanical work in relation to the magnetic volume of the permanent magnet and the electromagnet.

FIG. 7 shows a simple sketch of a permanent magnet having an excitation coil.

FIG. 8 shows an equivalent circuit diagram with Θₐ and Θ_{b}, which is considered to belong to the state of science and art and has been used so far.

FIG. 9 shows a model of an electromagnet.

FIG. 10 shows the magnetization characteristics of the electromagnet and the permanent magnet as well as the shear straight with the corresponding geometrical relationships.

FIG. 11 also shows the magnetization characteristics of the electromagnet and the permanent magnet as well as the shear straight and also determined measurement values for different air gap sizes.

FIG. 12 shows a variant of a flow chart for calculating reluctance system partners.

FIG. 13 shows another variant of a flow chart for calculating the reluctance system partners.

FIG. 14 shows a combination of the polygonal chain and the interpolation polynomial.

FIG. 15 shows a modulation function with six partial polynomials.

FIGS. 16, 17 show the occurrence of lateral pressure and longitudinal tension in relation to the magnetization function.

FIGS. 18, 19 compare the linear case with the nonlinear case of a magnetization in a vector diagram.

FIG. 20 shows a two-dimensional vector diagram for a nonlinear magnetization function of iron.

FIG. 21 shows a cut of the stator sheet metal of a three-phase motor.

FIG. 22 shows a partial section of a stator pole and of a rotor arranged on the opposite side.

FIG. 23 shows a development of the stator/rotor.

FIG. 24 shows the statically measured torque depicted over different currents as a function of the angle α.

FIGS. 25, 26 show the current profile over time, which was correlated with the motor steps.

FIG. 27 shows the conventional illustration of the voltage source equivalent circuit diagram and the current source equivalent circuit diagram.

FIG. 28 shows the equivalent circuit diagram that takes the influence of the reluctance system partners into consideration.

FIGS. 29, 30 show the energy density distribution of the electromagnet and the permanent magnet.

FIGS. 31, 32 show the mechanical work in relation to the magnetic volume of the electromagnet and the permanent magnet.

### DETAILED DESCRIPTION OF THE INVENTION

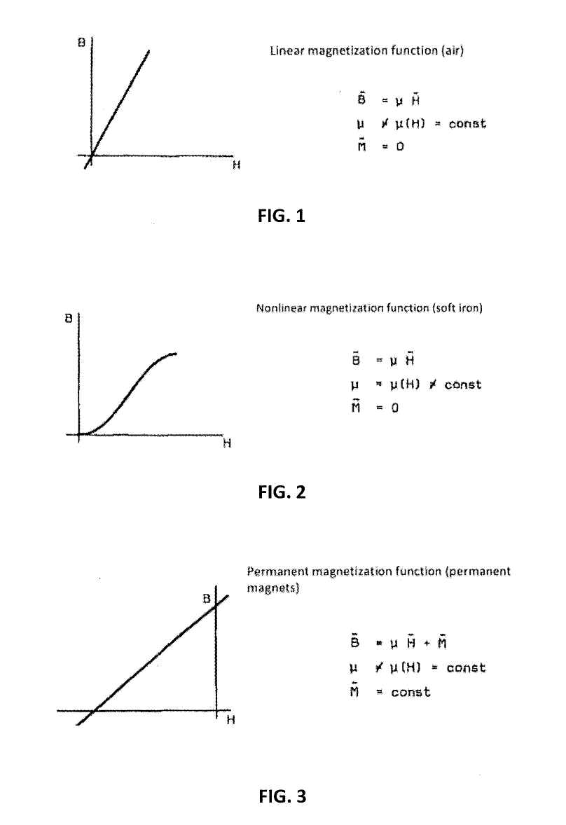

FIGS. 1, 2, 3 show the magnetization functions of the air gap, the soft iron and the permanent magnet. FIG. 1 shows a linear magnetization function in the air, FIG. 2 shows a nonlinear magnetization function for soft iron and FIG. 3 shows a permanent magnetization function for permanent magnets.

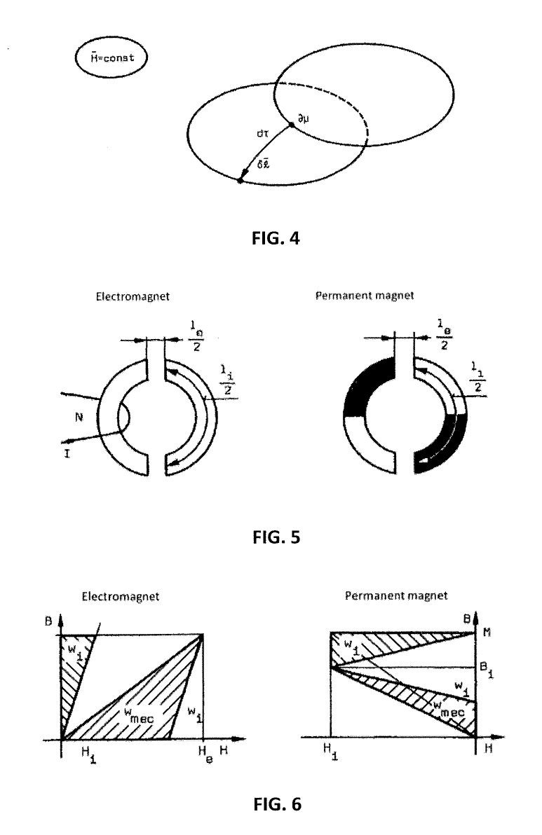

FIG. 4 shows the change of the permeability despite the external field being constant. When displacements occur in a constant external magnetic field, the permeability μ changes in the fixed point in space in a constant magnetic field H̅.

FIG. 5 shows a comparison of the electromagnet and the permanent magnet with the air gap measure lₑ/2 and the inner measure lᵢ/2 with a current I and a winding number N. The same also applies to the permanent magnet.

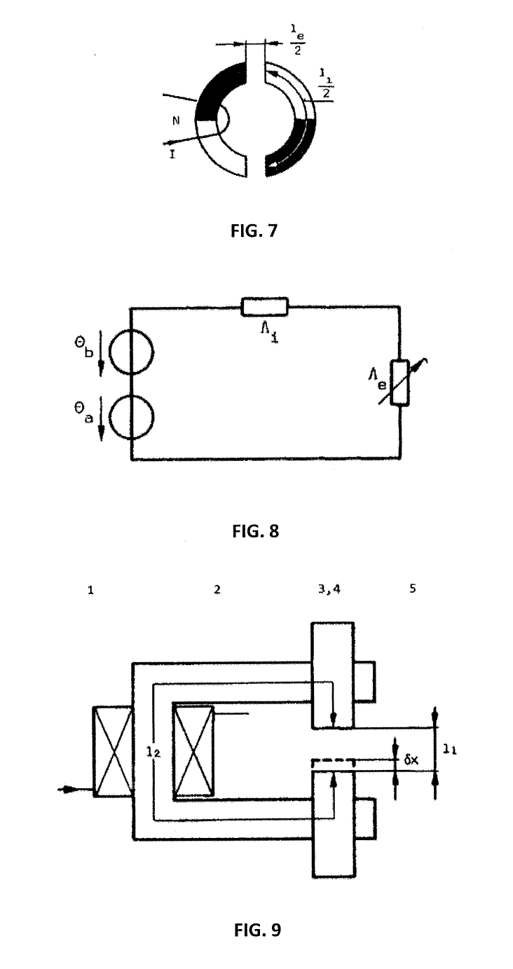

FIG. 6 shows a plot of the mechanical work in relation to the magnetic volume of the permanent magnet and the electromagnet, which are herein compared.

FIG. 7 shows a simple sketch of an electromagnet.

FIG. 8 shows an equivalent circuit diagram with Θₐ and Θ_{b}, which is considered to belong to the state of science and art and has been used so far.

FIG. 9 shows a model of an electromagnet with a yoke 1, a core 2, two armatures 3, 4 and an air gap 5.

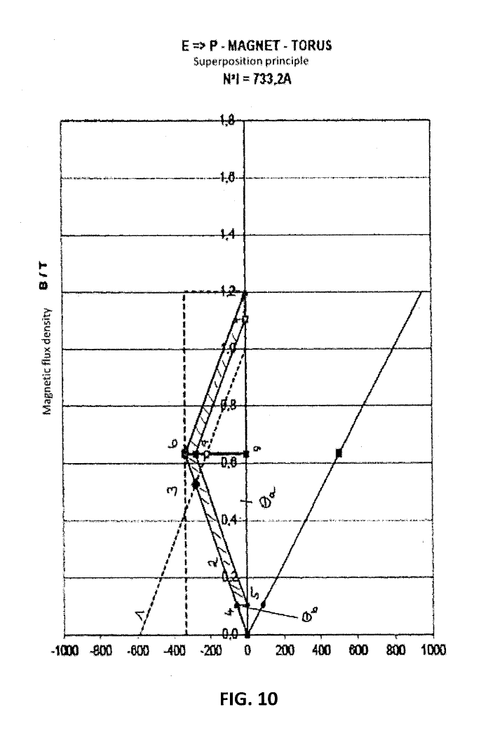

FIG. 10 shows the magnetization characteristics of the electromagnet and the permanent magnet as well as the shear straight with the corresponding geometrical relationships, wherein 1 is the intersection point between the magnetization characteristic of the permanent magnet and the abscissa, 2 is the shear straight of the reluctance system, 3 is the intersection point between the magnetization characteristic of the permanent magnet and the shear straight with I=0, 4 is the point on that shear straight that, with point 5, geometrically corresponds to Θb, 5 is the corresponding point on the ordinate, 6 is the recalculated working point of the reluctance system, at which the energy balance becomes a minimum, 7 is the displaced lower corner point of the parallelogram 4-5 6-7 with a width of Θb and a height of Θa (or vice versa)

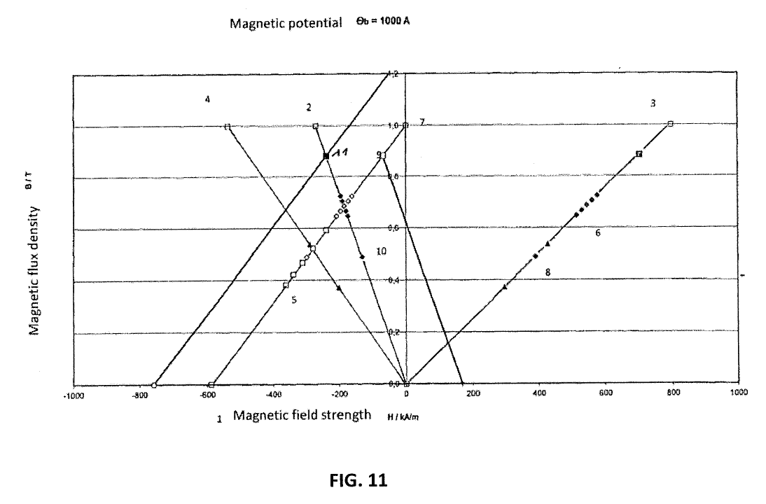

FIG. 11 shows the relationships of a reluctance system obtained by measurement, wherein 1 is the magnetization characteristic of the permanent magnet with a shear straight, 2 for an air gap width of 2 mm, 3 is the magnetization characteristic of the electromagnet, 4 is the shear straight of a reluctance system with an air gap width of 4 mm, 5 is a collection of measurement values on the magnetization function of the permanent magnet with an air gap width of 2 mm, 6 are the measured values of the magnetization function of the electromagnet, 7 is the intersection point of the magnetization function with the ordinate, 8 is the measured external working point of the electromagnet, 9 is the conventionally calculated working point of the permanent magnet and the electromagnet, 10 is the saturation point of the electromagnet, 11 is the measured working point of the permanent magnet and the electromagnet

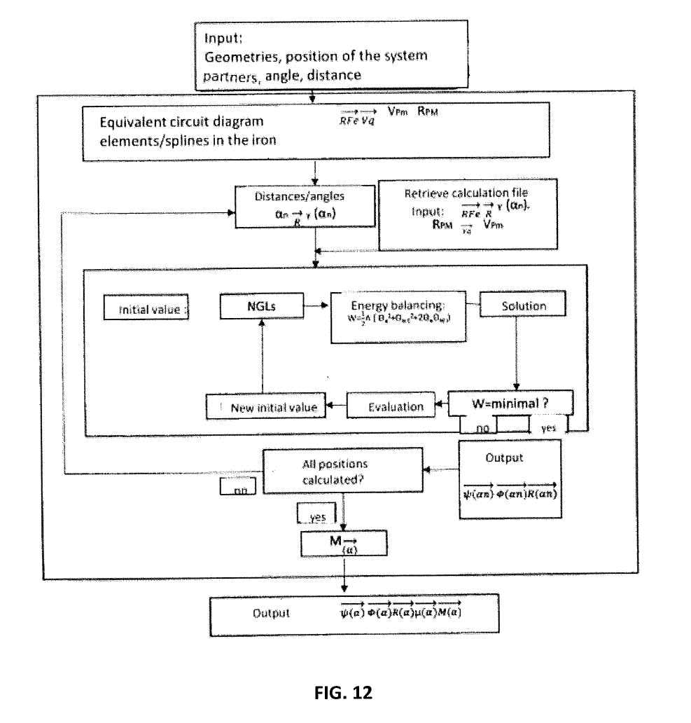

FIG. 12 shows a flow chart of a calculation algorithm, which can be used for calculating geometrically complex reluctance systems.

A new equation system is solved for each position of the electromagnet, as different air gap reluctances must be taken into consideration for each position. It starts with entering the geometries of the positions of the system partners (angle and distance) under consideration of the respective model. This results in a frame file determining the resistances in the iron parts. Depending on the input, these are output as constant values or as spline functions. On the basis of the considered rotor position αₙ, the air gap resistances are determined. All resistances and magnetic voltage sources serve as input data for the calculation program. The nonlinear equation system is calculated in a separate calculation file, which is retrieved from the frame file and contains the energetically balanced relevant quantities. Subsequently, the obtained values are evaluated, on the basis of which calculation the calculation of the separate calculation file is either terminated or recalculated with a new initial value. The equation system can be solved in several iteration steps. The zero vector is chosen as initial value. The output values comprise potentials, flux values and resistances of the magnetic circuit. This is repeated for each angle αn. At the end of the calculation, all results are summarized and the voltage induced in the coils and the branches as well as the torque of the system are determined.

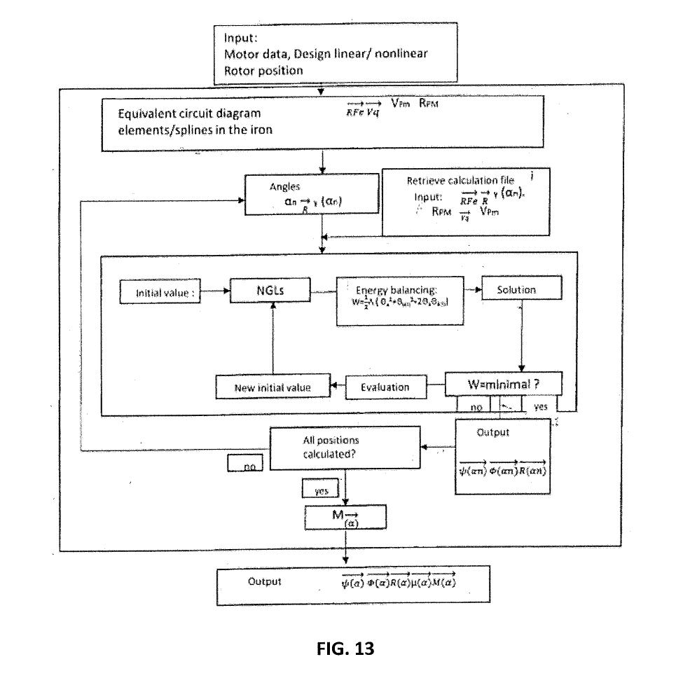

FIG. 13 shows the concretized variant for calculating an electromotor.

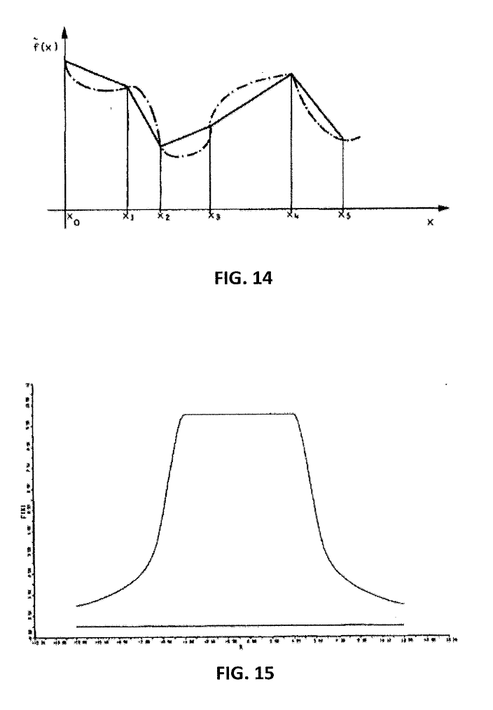

FIG. 14 shows the unsteadiness of a polygonal chain after the first derivation.

FIG. 15 shows a modulation function with six partial polynomials.

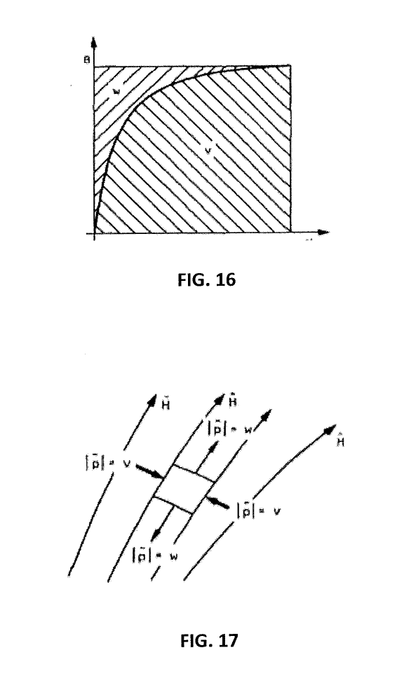

FIGS. 16, 17 show the occurrence of lateral pressure and longitudinal tension in relation to the magnetization function B as a function of H, wherein the tensional stresses differ from the compressive stresses.

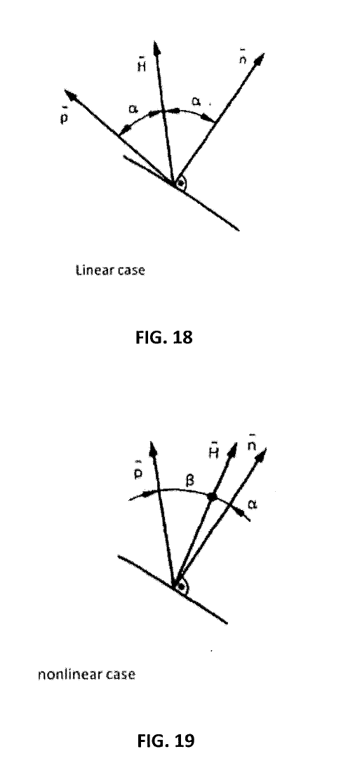

FIGS. 18, 19 compare the linear case with the nonlinear case of a magnetization in a vector diagram.

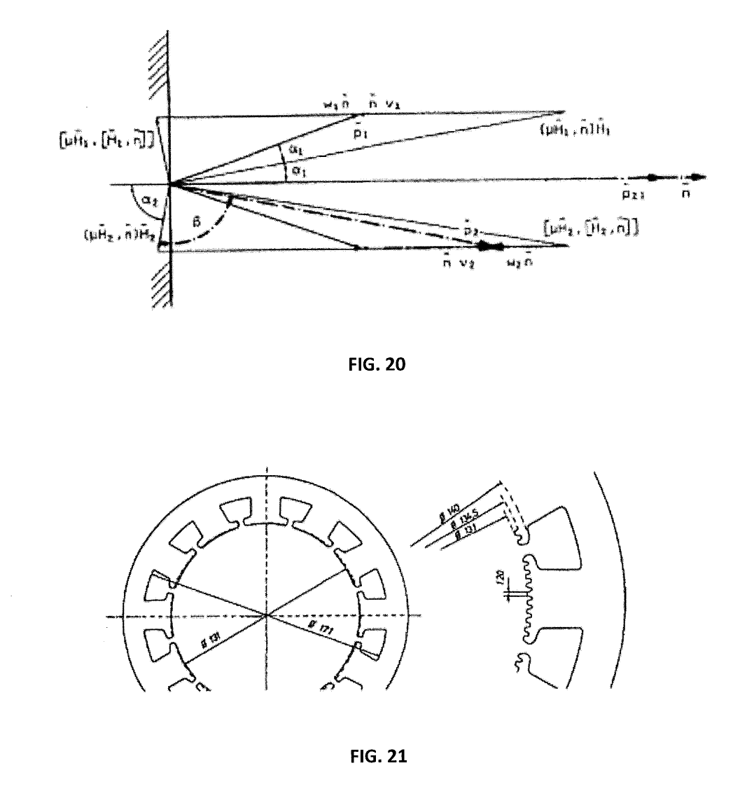

FIG. 20 shows a two-dimensional vector diagram for a nonlinear magnetization function of iron.

FIG. 21 shows a cut of the stator sheet metal of a three-phase motor.

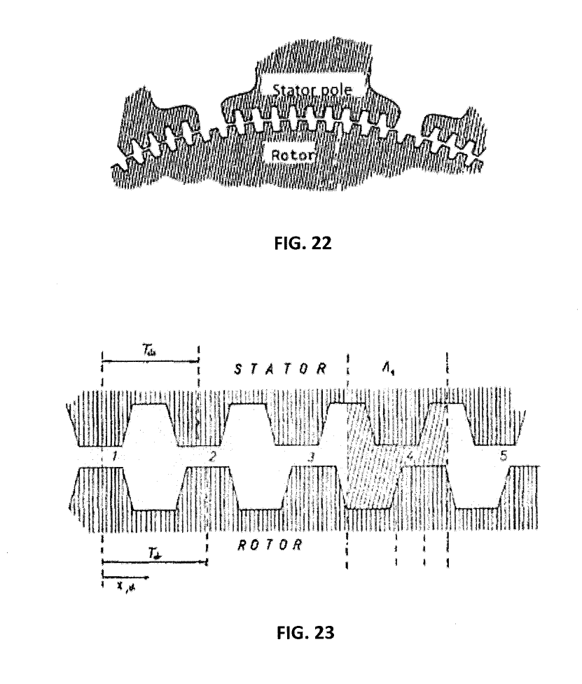

FIG. 22 shows a partial section of a stator pole and of a rotor arranged on the opposite side.

FIG. 23 shows a development of the stator/rotor.

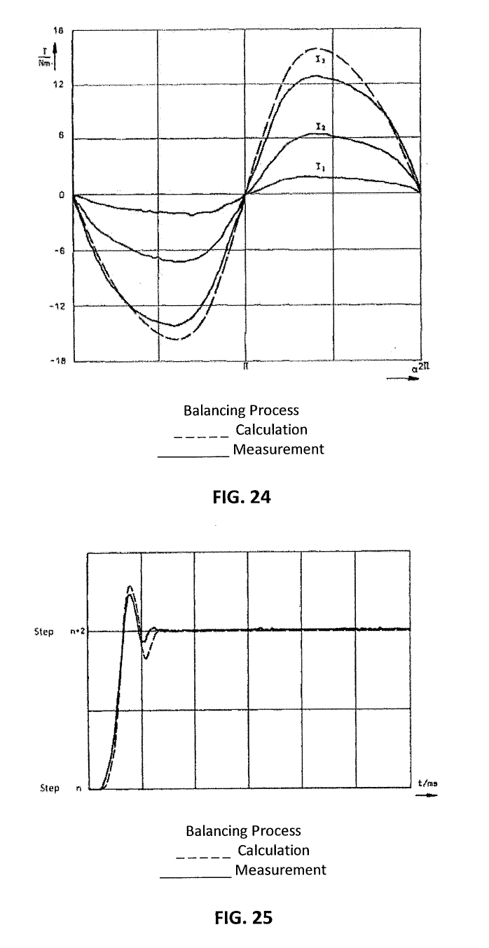

FIG. 24 shows the statically measured torque depicted over different currents as a function of the angle α.

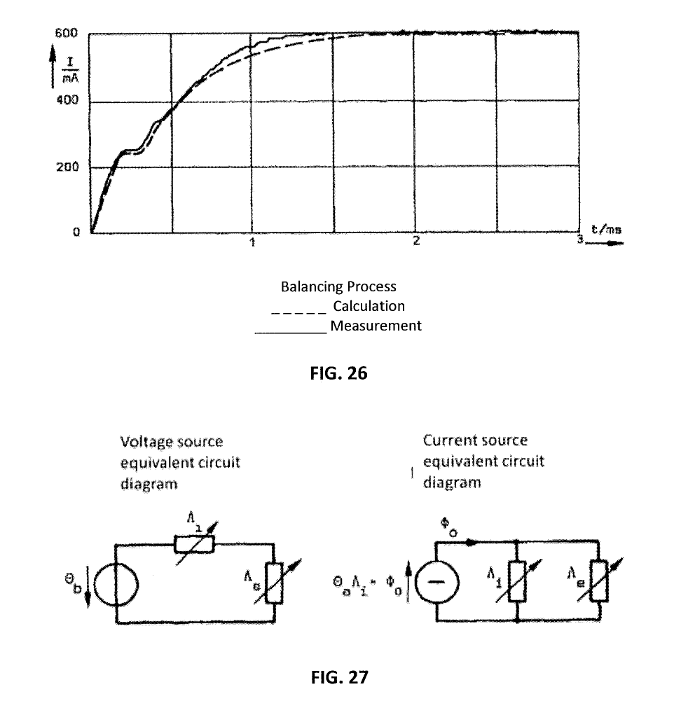

FIGS. 25, 26 show the current profile over time, which was correlated with the motor steps.

FIG. 27 shows the illustration of the voltage source equivalent circuit diagram and the current source equivalent circuit diagram, which take the inner energy densities under reciprocal influence into consideration.

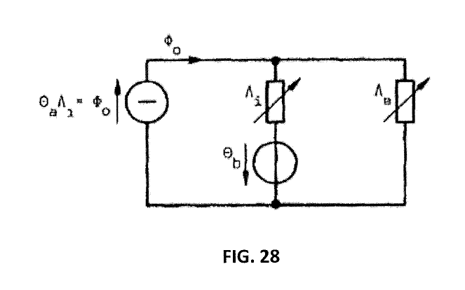

FIG. 28 shows the equivalent circuit diagram that takes the influence of the reluctance system partners into consideration.

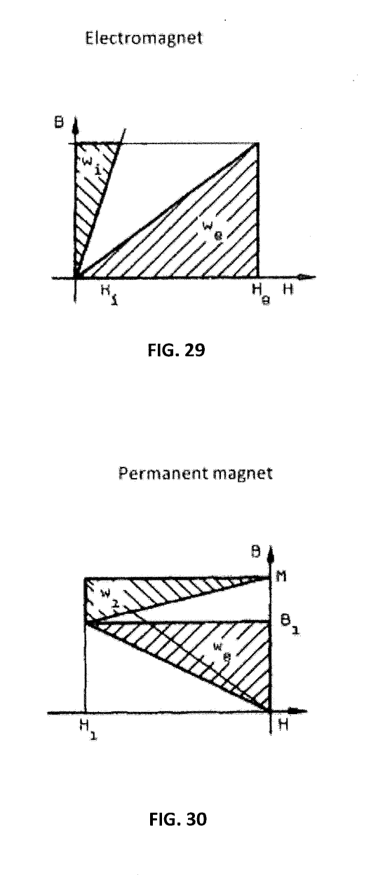

FIGS. 29, 30 show the energy density distribution of the electromagnet and the permanent magnet.

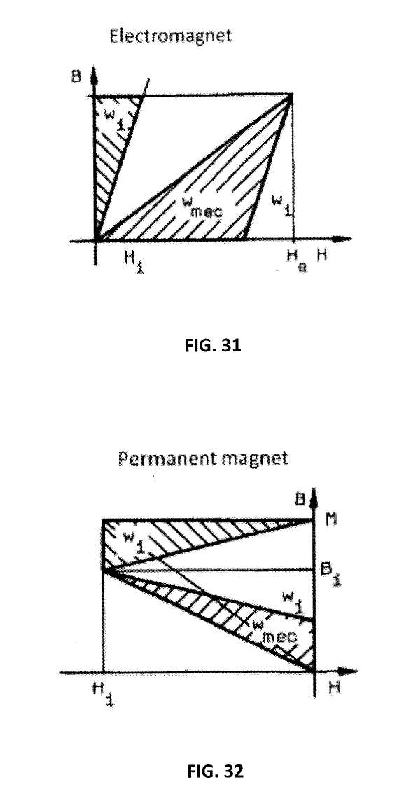

FIGS. 31, 32 show the mechanical work in relation to the magnetic volume of the electromagnet and the permanent magnet.

While the invention has been described with reference to exemplary embodiments and applications scenarios, it will be understood by those skilled in the art that various changes may be made and equivalents may be substituted for elements thereof without departing from the scope of the claims. Therefore, it is intended that the invention not be limited to the particular embodiments disclosed, but that the invention will include all embodiments falling within the scope of the appended claims and can be applied to various application in the industrial as well as commercial field.

The following applies:

### SIGNS AND SYMBOLS USED THROUGHOUT THE INVENTION

Ā vector area
B̅ magnetic flux density vector
D̅ electric flux density vector
Ē electric field strength vector
G region
H̅ magnetic field strength vector
I amperage
J̅ spatial current density vector
K random constant
M̅ magnetization vector
P̅ electrical polarization vector
Pₜₕ thermal power dissipation
P(x) Lagrange interpolation polynomial
R reduction factor
Ū general vector
V force function (general)
Vₘ magnetic force function
Vₑₗ electric force function
V̅ vector potential
W energy (general)
Wₘ magnetic energy
Wₑₗ electric energy
W_{m mec} mechanical energy, caused by the change in the magnetic energy
W_{el mec} mechanical energy, caused by the change in the electric energy
W_{mec} mechanical energy
F_{q} general force component
Wₑ outer energy
Wᵢ inner energy
Hₑ external magnetic field strength
Hᵢ internal magnetic field strength
[Ā, B̅] vector product
(Ā, B̅) scalar product
grad gradient
Grad area gradient
div divergency
Div area divergency
rot rotation
Rot area rotation
∇ nabla operator
∂ partial derivation
∂ change in the fixed point in space
δ [symbol] infinitely small displacement
ε permittivity
μ permeability
μ_{d} differential permeability
dτ volume element
ρₘ magnetic spatial density
Λ magnetic permeance
λ coefficient
Σ summation sign
σ potential of a double occupancy
ψ coil flux
α angle
β angle
Θ magnetic potential
Δ delta operator
Δdesignation of a difference
d′ total differential
d change in the fixed substantial point
d total differential
dĀ vectorial area element
dt time element
ds̅ vectorial line element
aₘ constant for boundary condition
bₘ constant for boundary condition
dₘ constant for boundary condition
e index for external
f̅ volume force (specific)
i instantaneous value of the amperage
ī unit vector in x direction
j̅ unit vector in y direction
k̅ unit vector in z direction
l length (general)
lᵢ internal length
lₑ external length
n̅ normal unit vector
p̅ normal unit vector
p̅ specific area force
p̅₂₁ specific area force on interfaces
q general coordinate
t parameter
u potential function
u scalar potential
Vₑₗ electric force density function
Vₘ magnetic force density function
Wₑₗ electric energy density
Wₘ magnetic energy density
z general complex number
\vec{p} fictive stress state in the non-linear medium
ψ̅(αn) magnetic interlinking flux dependent on the angle α
φ̅(αn) magnetic flux dependent on the angle α
R̅mag(αn) magnetic resistance dependent on the angle α

What is claimed is:

1. A calculation method for designing reluctance systems by balancing the inner and outer system energy using the equation W=1/2Λ(Θₐ²+Θ_{b}²+2ΘₐΘ_{b}), where 2ΘₐΘ_{b}≠0.

2. The calculation method according to claim 1, wherein a magnetic potential of an electromagnet Θ_{b} is a value that is dependent on a current (I), which value is to be selected such that W=1/2Λ(Θₐ²+Θ_{b}²+2ΘₐΘ_{b})becomes minimal, but is≧1, and the method further comprising:
a) using an initial value with I=0 and a second value I₁ ranging between I=0 and I=I_{Sättigung} (for Θ_{b}),
b) calculating an evaluation value B₁, which is a measure for leveling the balancing between Θₐ and Θ_{b} with W=1/2Λ(Θₐ²+Θ_{b}²+2ΘₐΘ_{b}),
c) calculating a second evaluation value B₂ for I₂ with the assumption I₁<I₂<<I_{Sättigung} for Θ_{b}.
d) with B₂<B₁, taking B2 as a new evaluation standard.

3. The calculation method according to claim 1, wherein prior to the energy balancing, the following steps are carried out:
a) inputting the data of the reluctance system partners;
b) determining the magnetic resistances as a function of the input data;
c) outputting the values of the values obtained in step b) as spline functions;
d) determining the magnetic intermediate range reluctances;
e) establishing at least one non-linear equation system with the values generated in steps b) through d);
f) leveling the nonlinearity of the equation system according to step e) by means of a mathematical model
ψ̅(αn)φ̅(αn)R̅mag(αn)
in order to obtain the output values.

4. The calculation method according to claim 3, wherein the leveling of the nonlinearity of the equation system, step f), is carried out by using the derived stress tensor P̅=−∫₀^{H′=H}μH′dH+μHₓ²; μHₓH_{y}; μHₓH₂.

5. The calculation method according to at claim 1, wherein the reluctance system is an electric motor consisting of a rotor and a stator.

6. The calculation method according to claim 3, wherein method step d) according to claim 3 is replaced by determining the air gap resistances as a function of the rotor position αₙ and wherein the last step according to claim 3 is followed by repeating the calculation of the air gap reluctances n times with the now obtained values for each rotor position αₙ.

7. The calculation method according to claim 6, wherein the last step is followed by another step, in which the induced voltage of the electric motor and the torque thereof are determined.

8. The calculation method according to claim 3, wherein the last step is followed by another step, in which the permanent magnet is dimensioned.

9. The calculation method according to claim 3, wherein an equivalent circuit diagram is used for determining the spline functions, which equivalent circuit diagram consists of a combination of a voltage source equivalent circuit diagram and a current source equivalent circuit diagram.

10. (canceled)

11. A non-transitory computer readable medium comprising software code sections adapted to perform a calculation method for designing reluctance systems by balancing the inner and outer system energy using the equation W=1/2Λ(Θₐ²+Θ_{b}²+2ΘₐΘ_{b}), where 2ΘₐΘ_{b}≠0
